(19) United States
(12) Patent Application Publication
(10) Pub. No.: US 2023/0047291 A1
(43) Pub. Date: Feb. 16, 2023

(54) ADJUSTABLE WIDTH ROLLER FOR PRODUCTS ROLLED ON TUBES

(71) Applicant: Peter D. Hall, Naplerville, IL (US)

(72) Inventors: James L. Hall, JR., San Francisco, CA (US); Peter D. Hall, Naperville, IL (US)

(21) Appl. No.: 17/400,871

(22) Filed: Aug. 12, 2021

(51) Int. Cl. F16C 13/00

(52) U.S. Cl. CPC F16C 13/006

(57) ABSTRACT

A device to be inserted into a cardboard tube used for rolled paper goods, the device providing a largely cylindrical interior surface for rolling on a spindle. The device comprising a first member and a second member. The second member comprises a second member body portion threads and the first member comprises a first member body portion threads, which are structured so that the first member body portion threads can be mated with the second member body portion threads, so that the first member body portion is secured inside a portion of the second member body portion. When the first member and the second member are secured together, they form a roller. The roller is inserted into a cardboard tube used to hold paper products to maintain the round structure of the cardboard tube via a first member first end flange and a second member first end flange.

### TECHNICAL FIELD OF THE DISCLOSED EMBODIMENTS

Embodiments of the present disclosure relate to a holder for rolled paper products, and more specifically, to a holder for rolled paper products on cardboard tubes.

### BACKGROUND

Currently, the cardboard tubes that hold rolled paper products can become deformed, for example during manufacture or transport, such that the tubes no longer retain their cylindrical shape. Due to this, the tubes do not roll smoothly on, for example, a toilet paper spring-loaded spindle. Because of the non-cylindrical shape of the interior of the cardboard tube, the cardboard tube does not rotate smoothly around the spindle and creates difficult tissue removal, vibration and noise.

### SUMMARY OF THE DISCLOSED EMBODIMENTS

According to embodiments of the present disclosure, devices for holding cardboard tubes used for rolled paper products are provided. The device may be used to provide a cylindrical (round cross-section) structure disposed inside a cardboard tube used for rolled goods. The device may comprise a first member, the first member may comprise a first member first end, a first member second end, a first member body portion, a first member first end flange, a first member body portion threads, and a first member body portion exterior surface. The device further comprising a second member, the second member comprising a second member first end, a second member second end, a second member body portion, a second member first end flange, a second member body portion threads and a second member body portion interior surface.

The first member body portion may be between the first member first end and the first member second end. The second member portion may be between the second member first end and the second member second end. The first member body portion threads may extend from the first member second end into a portion of the first member body portion. The second member body portion threads may extend from the second member second end into a portion of the second member body portion. The second member body portion threads and the first member body portion threads may be structured so that the first member body portion threads can be screwed into the second member body portion threads, so that the first member body portion is secured inside a portion of the second member body portion. The first member and the second member when secured together may form a roller. The roller may be inserted into the cardboard tube to provide a cylindrical (round cross-section) structure disposed inside the cardboard tube.

The first member body portion threads may be on an exterior surface of the first member body portion. The second member body portion threads may be on an interior surface of the second member body portion such that they may mate with the threads on the first body member portion. The roller may fit inside of a cardboard tube holding toilet paper, paper towels and other paper products. The roller may be inserted inside of the cardboard tube via a first end of the cardboard tube or a second end of the cardboard tube and may be secured inside of the cardboard tube by screwing the first member body portion threads into the second member body portion threads or vice versa. When the roller is secured together inside of the cardboard tube, the roller may provide a cylindrical (round cross-section) structure, so that the cardboard tube spins smoothly on a standard spring-loaded toilet paper holder spindle or similar paper product spindles. The roller may fit over the standard spring-loaded toilet paper holder spindle in one embodiment.

The first member first end flange and the second member first end flange, which are on opposite ends of the cardboard tube, may engage the cardboard tube so that the cardboard tube is made round and not able to deform into a less than round structure. The first member and the second member may be made from injection-molded plastic and other plastic materials.

### BRIEF DESCRIPTION OF DRAWINGS

The embodiments and other features, advantages and disclosures contained herein, and the manner of attaining them, will become apparent and the present disclosure will be better understood by reference to the following description of various examples of the present disclosure taken in conjunction with the accompanying drawings, wherein:

FIG. 1 depicts an embodiment of a first member of the present disclosure.

FIG. 2 depicts an embodiment of a second member the present disclosure.

FIG. 3 depicts an embodiment of an assembled roller of the present disclosure.

### DETAILED DESCRIPTION OF THE DISCLOSED EMBODIMENT

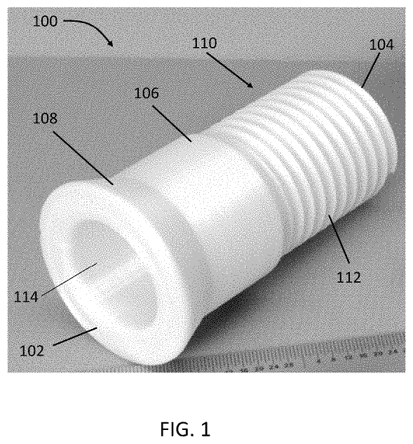

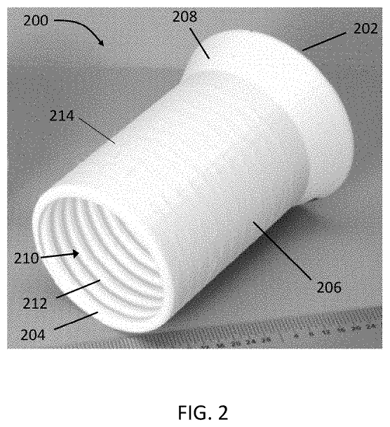

An embodiment of the present disclosure may comprise a first member 100, as illustrated in FIG. 1 and a second member 200, as illustrated in FIG. 2. The first member 100 may comprise a first member first end 102, a first member second end 104, with a first member body portion 106 therebetween. The second member 200 may comprise a second member first end 202, a second member second end 204, with a second member body portion 206 therebetween.

The first member first end 102 may comprise a first member first end flange 108, wherein the first member first end flange 108 extends from a first circumference of the first member body portion 106 to a second circumference that is larger than the first circumference. The first member 100 may further comprise first member body portion threads 110 extending from the first member second end 104 into the first member body portion 106. The first member body portion threads may be on an exterior surface of the first member body portion. The second member first end 202 may comprise a second member first end flange 208, wherein the second member first end flange 1208 extends from a third circumference of the second member body portion 206 to a fourth circumference that is larger than the third circumference. The second member 200 may further comprise second member body portion threads 210 extending from the second member second end 204 into the second member body portion 206. The second member body portion threads may be on an interior surface of the second member body portion such that they may mate with the threads on the first body member portion.

The second member body portion threads 210 on the interior surface 212 of the second member body portion 206 may be structured so that the first member body portion threads 110 may be mated with the second member body portion threads 210 on the interior surface 212 of the second member body portion 206. Thus, the first member body portion 106 may be secured inside a portion of the second member body portion 206 via the first member body portion threads 110 and the second member body portion threads 210 or other known methods to secure the first member body portion 106 inside of the second member body portion 206 or vice versa.

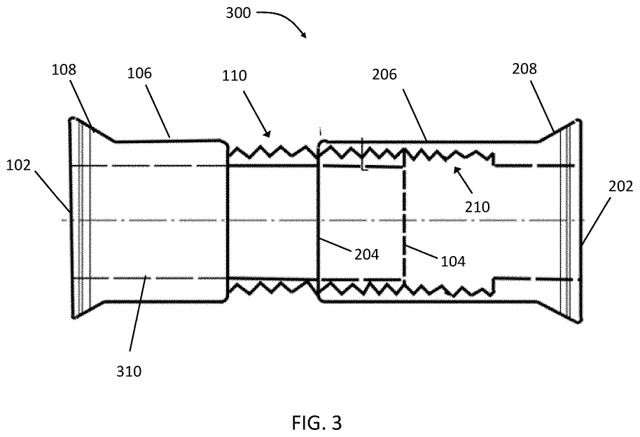

The first member 100 and the second member 200 when combined may form a roller 300, as illustrated in FIG. 3. The roller 300 may fit inside of a cardboard tube (not shown), for example, a toilet paper roll and other cardboard tubes that may hold other rolled goods, such as paper towels to name just one non-limiting example. The roller 300 may be inserted inside of the cardboard tube by inserting the first member 100 into a first end of the cardboard tube (not shown) and inserting the second member 200 into a second end of the cardboard tube (not shown) and may be secured inside of the cardboard tube by screwing the first member body portion threads 110 into the second member body portion threads 210 or vice versa (not shown). Once the roller 300 is secured together inside of the cardboard tube, the roller 300 may create a rounder cardboard tube. Furthermore, the interior surfaces 114 and 212 provide consistent cylindrical shape across the length of the roller 300 so that the roller 300 may spin smoothly on a standard spring-loaded toilet paper holder spindle 310 (or holder spindle for any other rolled paper goods).

The first member first end flange 108 and the second member first end flange 208, which may be on either end of the cardboard tube, may engage the cardboard tube so that the cardboard tube is round and not deformed or less than round. The roller 300 may fit over the standard spring-loaded toilet paper holder spindle 310 (or holder spindle for any other rolled paper goods).

The first member 100 and the second member 200 may be made from any suitable material, for example, injection-molded plastic and other materials, so long as the first member body portion threads 110 and the second member body portion threads 210 are strong enough to hold the tension on the first member body portion threads 110 and the second member body portion threads 210, when the first member 100 and the second member 200 are assembled together to form the roller 300.

While the present disclosure has been illustrated and described in detail in the drawings and foregoing description, the same is to be considered as illustrative and not restrictive in character, it being understood that only certain embodiments have been shown and described, and that all changes and modifications that come within the spirit of the present disclosure are desired to be protected.

1. A device adapted to be disposed inside a cardboard tube used for rolled goods, the device comprising:
a first member, the first member comprising a first member first end, a first member second end, a first member body portion, a first member first end flange, a first member body portion threads, and a first member body portion exterior surface;
a second member, the second member comprising a second member first end, a second member second end, a second member body portion, a second member first end flange, a second member body portion threads and a second member body portion interior surface;
wherein the first member body portion is between the first member first end and the first member second end, and the second member body portion is between the second member first end and the second member second end;
wherein the first member body portion threads extend from the first member second end into the first member body portion and the second member body portion threads extend from the second member second end into the second member body portion;
wherein the first member body portion threads and the second member body portion threads are constructed and arranged so that the first member body portion threads can be mated with the second member body portion threads, so that the first member body portion is secured inside a portion of the second member body portion;
wherein the first member and the second member when secured together form a roller, the roller being constructed and arranged to be inserted into the cardboard tube to provide a cylindrical structure within the cardboard tube between the first member first end flange and the second member first end flange, such that the cylindrical structure provides a consistent cylindrical shape between the first member first end flange and the second member first end flange.

2. The device of claim 1, wherein the first member body portion threads are on an exterior surface of the first member body portion and the second member body portion threads are on an interior surface of the second member body portion.

3. The device of claim 1, wherein the roller fits inside of a cardboard tube holding toilet paper or paper towels.

4. The device of claim 1, wherein the roller is inserted inside of the cardboard tube via a first end of the cardboard tube or a second end of the cardboard tube and is secured inside of the cardboard tube by screwing the first member body portion threads into the second member body portion threads or vice versa.

5. The device of claim 1, wherein when the roller is secured together inside of the cardboard tube, the roller makes the cardboard tube round, so that the cardboard tube spins smoothly on a spring-loaded toilet paper holder spindle.

6. The device of claim 5, wherein the roller fits over the spring-loaded toilet paper holder spindle.

7. The device of claim 1, wherein the first member first end flange and the second member first end flange, which are on opposite ends of the cardboard tube, engage the cardboard tube so that the cardboard tube is not able to deform into a less than round structure.

8. The device of claim 1, wherein the first member and the second member are made from injection-molded plastic.

9. The device of claim 1, wherein the cylindrical structure extends along an axis, wherein a length of the cylindrical structure along the axis is greater than a length of the first member first end flange, and wherein the length of the cylindrical structure along the axis is greater than a length of the second member first end flange.

10. The device of claim 1, wherein the first member body portion comprises a first member unthreaded portion interposed between the first member first end flange and the first member body portion threads, and wherein the second member body portion comprises a second member unthreaded portion interposed between the second member first end flange and the second member body portion threads.

11. The device of claim 10, wherein the first member unthreaded portion comprises a first member shoulder opposite the first member fist end flange, and wherein the second member unthreaded portion comprises a second member shoulder opposite the first member fist end flange.

12. The device of claim 11, wherein, when the first member shoulder and the second member shoulder are linearly coextensive.

13. The device of claim 12, wherein, the first member shoulder and the second member shoulder are configured to abut one another when the first member body portion threads and the second member body portion threads are entirely engaged.
